(19) United States
(12) Patent Application Publication
(10) Pub. No.: US 2018/0039981 A1
(43) Pub. Date: Feb. 8, 2018

(54) System for receiving value from an electronic cash register to an electronic value system using a user device.

(71) Applicants: Wayne Allison, Edmond, OK (US); Jacob William Allison, Edmond, OK (US)

(72) Inventors: Wayne Allison, Edmond, OK (US); Jacob William Allison, Edmond, OK (US)

(21) Appl. No.: 15/231,305

(22) Filed: Aug. 8, 2016

(51) Int. Cl. G06Q 20/38; G06Q 20/32; G06Q 20/20

(52) U.S. Cl. CPC G06Q 20/381; G06Q 20/202; G06Q 20/208; G06Q 20/327

(57) ABSTRACT

A system for currency conversion comprising a currency with at least one denomination, at least one electronic cash register adapted to receive and retain at least one currency further having a module in communication with each register, at least one user device in communication with at least one module, the device including at least one user controllable command, user identification information, and system authentication information, at least one user account adapted to receive and retain the value associated with at least one currency-paid transaction processed by at least one register, at least one redemption outlet adapted to allow at least one user to apply any value in their user account to a desired purpose whereby each user retains the value associated with currency-paid transactions without the necessity of receiving and dealing with physical currency.

### CROSS-REFERENCE TO RELATED APPLICATIONS

This application claims priority of provisional Patent Application No. 62/202,809 filed Sep. 8, 2015.

### FIELD OF THE INVENTION

The present invention generally relates to a currency conversion and value storage system. In particular, the invention relates to a system for converting currency received during a point of sale transaction into electronic value using an electronic cash register communicating with a user device that updates a user account based on the currency value received.

### BACKGROUND

Millions of currency consumer transactions occur daily throughout the world. These transactions often involve the exchange of currency for the items to be purchased. In the modern and evolving world, currency has had many transformations from paper and coinage to electronic currency to include bitcoins. Electronic currency may be separated into many forms including mediums such as a debit, credit, gift card, or the like. Additionally, currency exchanges may occur electronically through the Internet or through systems such as Apple Pay®, Google Wallet®, and the like. The advantage of these electronic transactions is that there is no residual paper or coin currency.

Forty-percent of all consumer transactions in the United States at the present time are conducted with currency (hereinafter “cash”), specifically the U.S. dollar. Two-thirds of all transactions under ten dollars are conducted with cash. During a consumer transaction, a consumer selects an item to purchase and exchange, cash for the item. In many cases, if not most, the consumer exchanges cash greater than the price of the item and will receive the residual cash back in the form of paper and coins. Many people place the residual coins and small denominations of paper in ash trays or consoles of vehicles, change jars and all other means of storage. Receiving the residual coins and small paper denominations are a hassle to a consumer, because it falls out of pockets, it is heavy, it accumulates in strange places, and is nearly impossible to accumulate and keep track of.

To address the residual cash issue, the current invention allows users to convert physical cash from a point of sale transaction into an electronic value that resides in a user's account. This value remains in the account until the user decides to redeem the value for example by making purchases with traditional or online retailers. Additionally, a portion of the value of the account may be transferred to organizations like charities. By converting the residual amount of cash into electronic value it eliminates the problem of storage and tracking of loose change and also the conversion of that change into larger denominations of currency.

### SUMMARY OF THE INVENTION

The invention relates to a system for converting residual currency from an electronic cash register transaction into electronic value that a user may use later. The user may purchase items or services or donate accumulated value to different organizations that have accounts. Under the current state of the art, a user selects an item to purchase, the attendant rings up the purchase using an electronic cash register and the electronic cash register calculates the amount of cash to return to the user. The attendant then hands the residual cash to the user which may be in the form of coinage or paper.

The present invention allows users to covert physical cash from an electronic cash register sales transaction into an electronic value that resides in a user's account for later use. The present invention allows a user to select an item to purchase, the attendant rings up the sale using an electronic cash register and the electronic cash register calculates the amount of cash to return to the user. Then user decides if they want cash or would like the attendant to transfer the value of the residual cash from the electronic cash register to the user's account through the user device, using methods including but not limited to wired, wireless, coding using Universal Product Code (UPC) and/or quick response codes (QRC) and magnetic cards.

This conversion may be performed using an electronic cash register or similar point of sale “POS” devices and user device(s) including but not limited to smartphones, tablets and the like. Once the value transfer has occurred, then the user account is updated and reconciled by the system using retailer and user information. The user account shows the increase in the user account balance.

As users accumulate value in their user accounts they will want to make purchases with these accumulated amounts. A user may make purchases with the value maintained in the user account with traditional or online retailers. The user may also use the account to make donations to national organizations and charities such as United Way, Ronald McDonald House, and many others or donations to a local church, club or school parents-teacher organization. Additionally, a user may transfer value to a virtual currency such as BitCoin. The organizations may set up organizational accounts that similarly function as a user account so they can receive and expend the value in the organization account.

Retailers may enter into the currency conversion system through revenue-sharing relationships and networking with the system server allowing the retailers to transfer value to and from the user's or organization's account. Additionally, the retailers may encourage the users through advertisements delivered to user's devices. Retailers may also utilize geo-fencing and geo-targeting to encourage the user to purchase items when users are in close proximity to a retailer

The present invention fulfills the need for converting residual currency from a consumer transaction into an electronic value for the user to utilize in the future for a possible consumer transaction. It eliminates the need to store and track loose currency such as coinage and eliminates the need to convert from small denominations into larger denominations for ease of transport and storage.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a diagrammatic representation of one embodiment of the payment system.

FIG. 2 is a diagram illustrating a system configuration.

FIG. 3 is a diagram illustrating the contents of a version of a database.

FIG. 4 is a process flow diagram illustrating one method for creating a user account.

FIG. 5 is a process flow diagram illustrating one method for creating an organizational account.

FIG. 6 is a process flow diagram illustrating one method for a user to configure their account.

FIG. 7 is a process flow diagram illustrating one method for selecting a user action.

FIG. 8 is a process flow diagram illustrating one method of the automatic payment process.

FIG. 9 is a process flow diagram illustrating one method for sales transaction.

FIG. 10 is a process flow diagram illustrating one method for location notification.

FIG. 11 is a diagrammatic illustration of geofencing using the currency conversion system.

FIG. 12 is a view of one embodiment of a electronic cash register communication module.

FIG. 13 is a view of one embodiment of a user device.

### DETAILED DESCRIPTION OF THE INVENTION

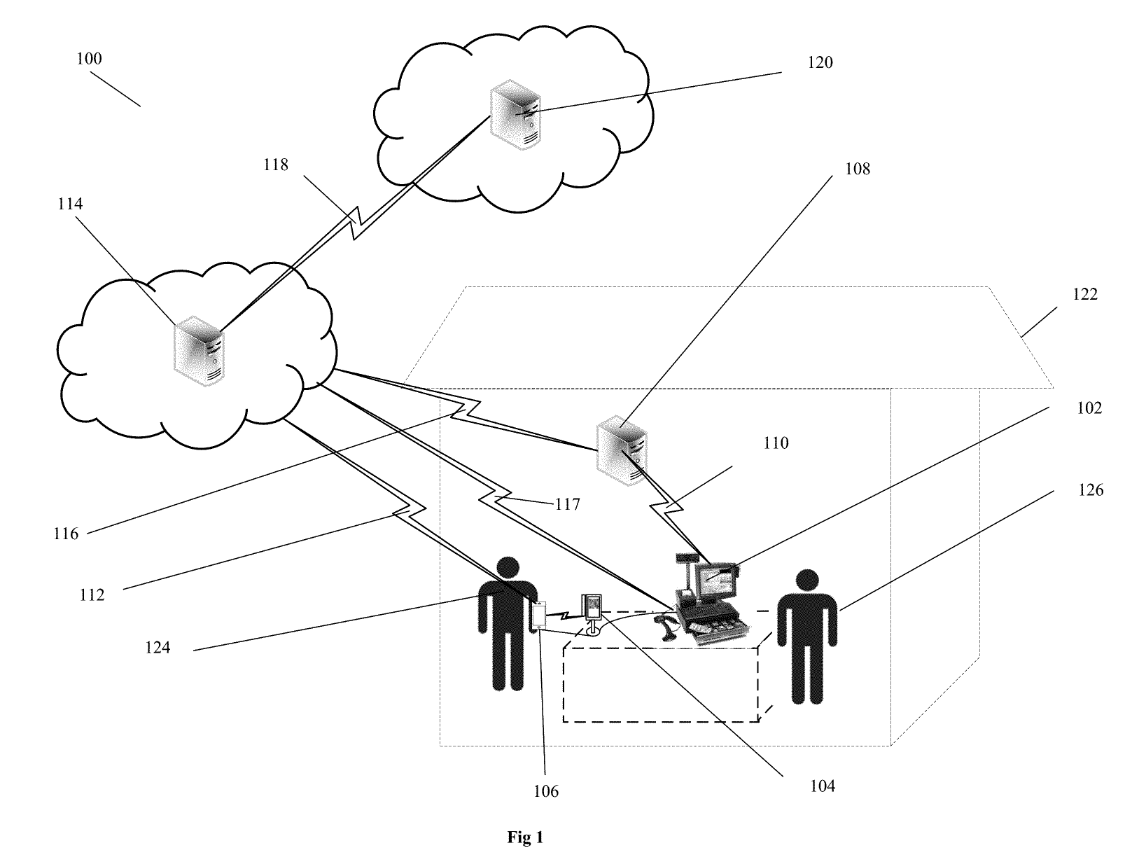

FIG. 1 is a diagrammatic representation of one embodiment of a currency conversion system 100 according to the present invention. This preferred embodiment may include an electronic cash register 102, a communication module 104, a user device 106, a user 124, an attendant 126, a user device wireless communication path 112, a redemption outlet server 114 and a retail store server 108. Other embodiments may include wired, wireless, and hybrid networks and other internet 214 implementations. The user device 106 may be selected from a desktop, a laptop, and a smart mobile device where the smart mobile device may include a smart phone, tablet, watch, and card.

In a cash transaction using the system, a user 124 enters the retail store 122 and desires to purchase a good or service (hereinafter “item”) from the retailer wherein user 124 selects the item and engages the attendant 126 at the counter where they start the sales transaction. The attendant 126 uses the electronic cash register 102 to determine and provide the user 124 with the price of the item. The user 124 then provides the attendant 126 with currency to purchase the item. Upon purchasing the item, there may be residual currency due the user 124 that is in excess of the price paid for the item. In the current state of the art, at the end of the sales transaction action, the attendant 126 would likely band the user 124 the residual currency possibly containing loose coins and small denomination bills. The user 124 would then place the coins in their pocket or in the ashtray, console, or drink holder of the car or some other place for it to be collected over time requiring it to be converted to larger denomination bills for ease of use.

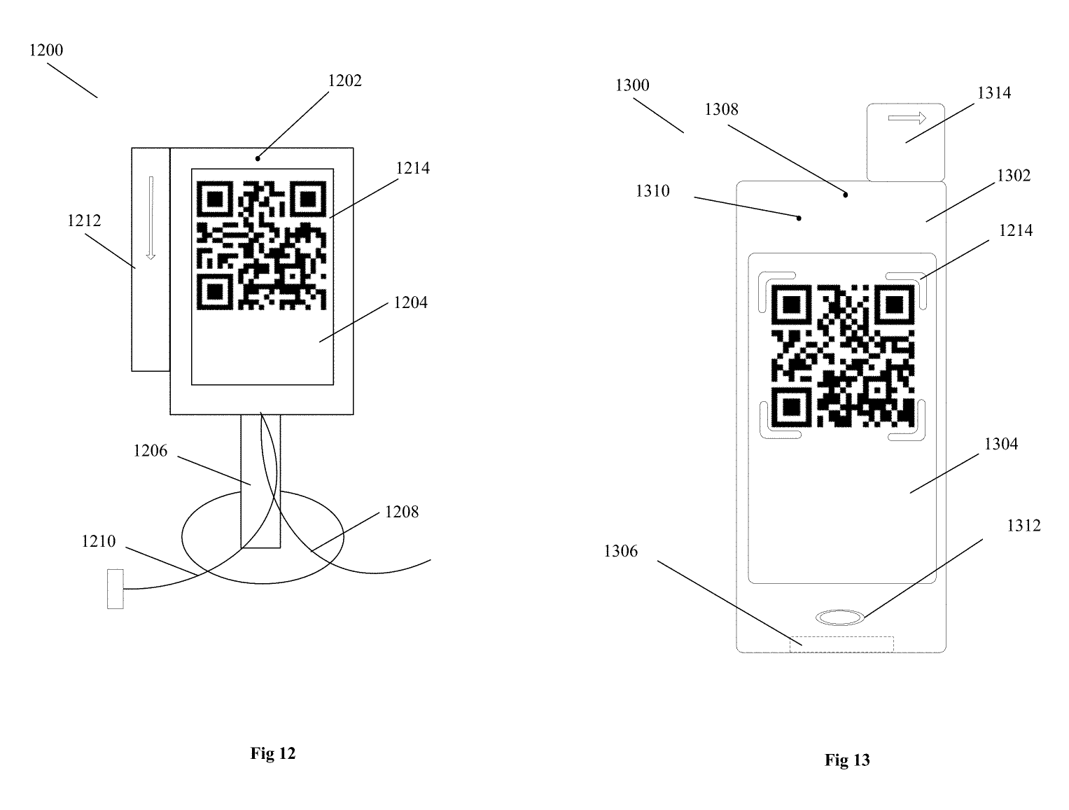

However, with the present embodiment the currency conversion system 100 allows the attendant 126 at the request of the user 124 to convert the residual currency to electronic value through the electronic cash register 102 and transfer that value to the user's 124 account directly or via a user device 106. Additionally, information associated with the sales transaction may also be transferred to the user device 106. This transfer may occur using the electronic cash register 102 and the cash register's communication module 104 wherein it communicates with the user device 106 by one of several methods discussed later in FIGS. 12 and 13 and provides the user 124 with the value of the residual currency that they were to receive from the sales transaction.

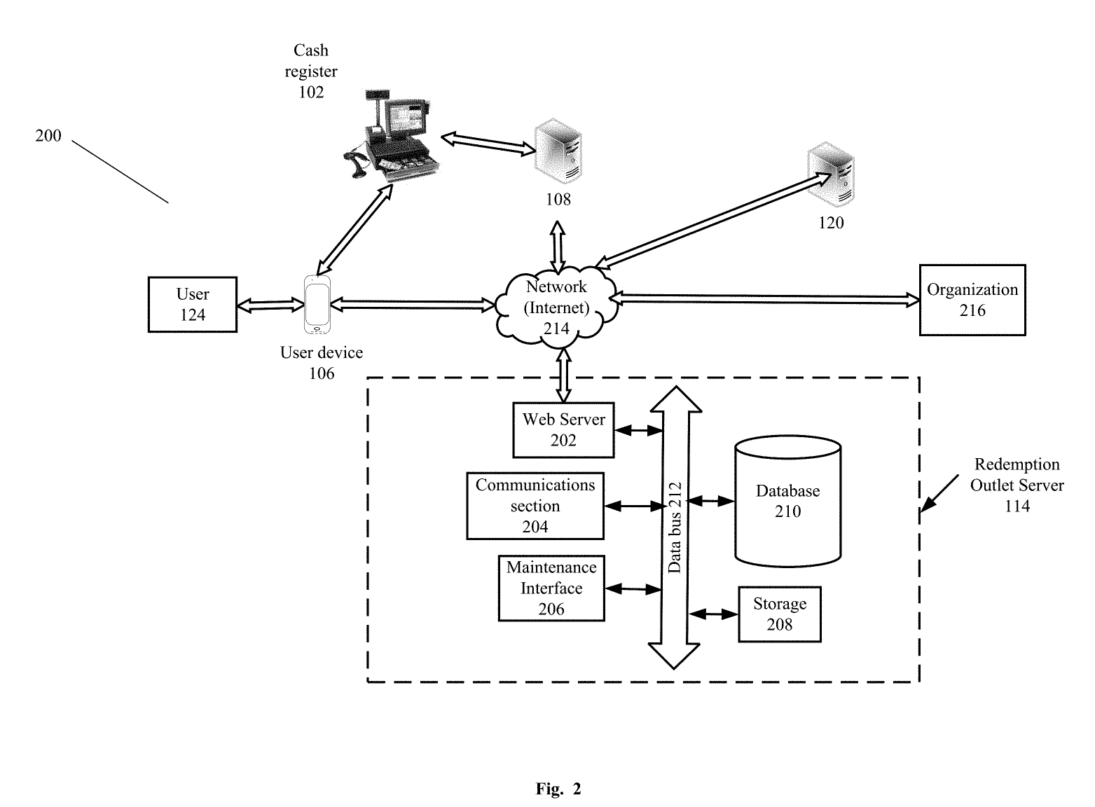

The user device 106 may transfer the sales data including the residual value to the redemption outlet server 114 via a user device wireless communications path 112. The redemption outlet server 114 receives the data from the user device 106 and adds the sales data to the value in the user's account within the database 210 described in FIG. 2.

The electronic cash register 102 may communicate with the retail store server 108 wirelessly through the retail store communication path 110. The retail store server 108 may be housed locally inside the retail store 122 or may be housed remotely at another location. The communication may also be conducted using a wired path between the electronic cash register 102 and the retail store server 108. The retail store server 108 may then communicate with the redemption outlet server 114 through a wireless or wired redemption outlet server communication path 116 via Internet 214 and transfer sales transaction data 304 to the redemption outlet server 114. Alternately, the electronic cash register may communicate directly 117 with the redemption outlet server 114 to provide the sales data. Once the user device 106 and the electronic cash register 102 have communicated with the redemption outlet server 114 transferring sales data, the redemption outlet server 114 reconciles and updates the user's 124 account in the database 210. This update may be viewed on the user device 106.

The redemption outlet server 114 may be connected to a redundant server 120 through a redundant communication path 118 where the same information resides on both servers and if one of the servers was to fail that information then would be backed up on the other server. This redundant communication path 118 allows for the redemption outlet server 114 and redundant server 120 to be in constant communication and exchanging and updating data. Additionally, the redundant server 120 may also perform as a regional server where in the retailers and users 124 within a region would utilize a regional server and their information would be stored within that regional server database and provide more tailoring of the system based on the regional preferences. This may prevent the need for a single a massive database on a single server in a single location likely decreasing the speed and responsiveness to the user 124 but would instead allow for multiple databases based on the purchasing habits of the user 124 within a specific region or area of the country. For example, in the state of Oklahoma, a user 124 may consistently purchase items from 7-Eleven® whereas a different user 124 living in Texas may purchase items from a Quick Trip®, and having regional server databases that are specific to the areas would simplify the type of database and the size of the database and may also prevent or minimize the possibilities of interruptions of service.

In the present invention, the residual currency from a sales transaction may be converted into electronic value. Additionally, a user 124 that has additional currency may have the attendant 126 add the value of the additional currency to the residual currency before converting it to electronic value. For example, if a user 124 bought a item from a retailer and had a residual currency of 50 cents but also had 75 cents in their pocket that they no longer wanted to carry around, they may ask the attendant 126 to add $0.75 it to the residual value of 50 cents thereby converting the value into $1.25 of electronic value. In the alternative, the user device 106 may ask if the user 124 wanted to add additional value to the account and provide directions on how to do so.

FIG. 2 is a diagram illustrating an alternative system configuration 200. This embodiment may include a user 124, a user device 106, an electronic cash register 102, a retail store server 108, the internet 214, an organization 216, a redundant server 120, and the redemption outlet server 114.

A user device 106 allows the user 124 to receive value from a retailer via the electronic cash register 102 and the communication module 104. It wirelessly communicates with the redemption outlet server 114 providing sales information. The user device 106 may also allow the user 124 to perform functions, including but not limited to, checking electronic value balances, updating account configurations, setup automatic payment process, and control location updating. The user device 106 has a hardware component and a software component that may be in the form of a mobile application, though the software component may not be permanently installed on a user device 106.

The hardware component of the user device 106 may be a smartphone or other mobile device such as a Blackberry®, a tablet, or similar devices. One embodiment of the user device 106 is further described in FIG. 13. The user 124 communicates with the user device 106 and network 214 using a software component of the user device 106, The software component of the user device 106 preferably consists of a graphical user interface (GUI) or a mobile application that allows a device to connect to through the network 214 to a website hosted on the redemption outlet server 114. The user 124 GUI may consist of a standard internet web browser such as Internet Explorer®, Firefox Mozilla®, etc., in communication with the system website GUI. The mobile application on the user device 106 may be a software program tailored to its specific mobile device platform and, if installed on the user device 106, is preferably downloadable via the web site by the user 124. This combination of hardware and software enables a user 124 to interface with the redemption outlet server 114 via the user device 106.

A user device 106 may be able to provide a user's 124 location to the system 100 if the user 124 has an automatic positioning capability and allows the system 100 to automatically track their location. The application may ask the user 124 if they will allow the location information to transmitted back to the system. The automatic positioning capability can come in one of many forms; multilateration, triangulation, global positioning, WI-FI or a hybrid system incorporating two or more of the foregoing technologies.

Multilateration and triangulation are ground-based methods by which a user's 124 location is determined by series of radio towers communicating with the mobile device, using the time difference of arrival (TDOA) or angle of arrival (AoA) measurements respectively, to determine a user's 124 location.

Global positioning uses a satellite navigation system known as Globalnaya navigatsionnaya sputnikovaya sistema or GLObal NAvigation Satellite System (GLONASS) operated by the Russian Aerospace Defense Forces systems spaced-based or the Navigation Satellite Timing and Ranging System (NAVSTAR) Global Positioning System (GPS) operated by the United States. Both systems use satellites to provide location and time information in all weather conditions, anywhere on or near the Earth where there is an unobstructed line of sight to four or more satellites.

Wi-Fi-based positioning system uses a database of Wi-Fi access points where the location is determined by the signal strength between the mobile device and the known locations of these access points in the database. Based on this information, the location can be determined by combining this data and locating a common intersection point. The more access points the greater the accuracy of the location of the user 124. This system is particularly useful in urban areas with high-rise buildings preventing the line of sight needed for GPS and the user 124 being indoors.

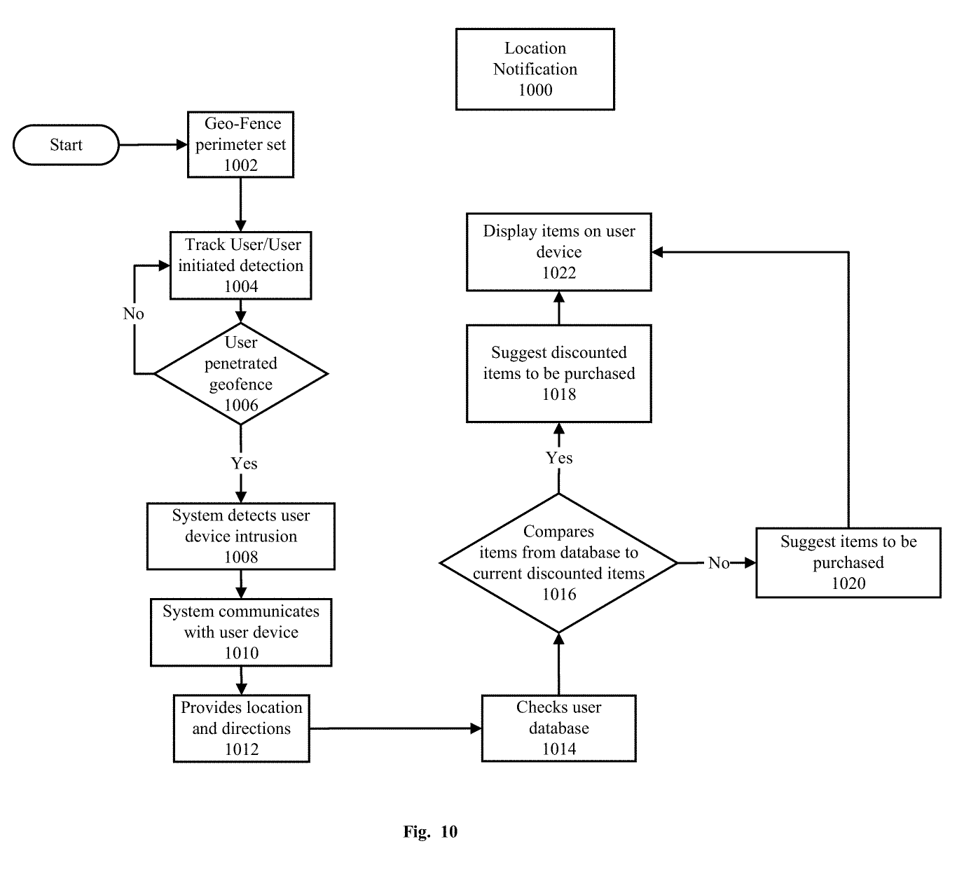

The hybrid positioning system uses a combination of the above positioning systems described to supplement the other systems to create a location solution. For example, one hybrid mode may be the “Assisted GPS” mode where the device may only have access to three satellites and the other system provides the remaining piece of location information in order to determine the user's 124 current location. If the user 124 decides not to allow the automatic positioning system to be utilized, then the user 124 may not be subject to geo-fencing and geo-targeting as described in FIG. 10.

An electronic cash register 102 is a system designed to enable items to be sold at a retail outlet. Electronic cash registers 102 calculate sales transactions and they help retailers track sales, collect purchase data, collect inventory data and much more. Moreover they may send data to sales and inventory software after the sale is complete to a retail store server 108 for updating and storing on the store's database 210. The electronic cash register 102 may be connected to a retail store server 108 where the sales data collected maybe stored. Most electronic cash registers 102 consist of a keyboard that is used to input entries, a scanner of some sort, a drawer that is used to hold cash, a printing device for receipts and an internal computer and software. Additionally, electronic cash registers 102 may perform additional functions, including but not limited to, the ability to process credit cards, conduct check verification, and use technologies such as Apple Pay®, Google Wallet®, etc. An electronic cash register 102 is well-known in the art and is incorporated by reference.

A retail store server 108 may have a similar internal configuration as a redemption outlet server 114. See below for a detailed description. One purpose of the retail store server 108 may include but is not limited to the storing of the sales data, calculating profits and losses, determining inventory, predictive ordering and employee information. in a larger company, the retail store server 108 may communicate with other company servers transferring the data back and forth to provide the company headquarters visibility on the retailers operations. In the current invention, this retail store server 108 and/or the electronic cash register 102 may communicate and transfer sales data to the redemption outlet server 114.

The organization 216 process allows multiple organizations to be part of the system 100. These organizations 216 may be national organizations such as the American Red Cross, United Way or Ronald McDonald House, local groups such as a local church, club or school parent teacher organization, fraternity, and single events such as funding summer camp for boy scouts that may not be able to attend otherwise. The organizations 216 may function in the same way that users 124 operate but with an additional step. The organization 216 must setup an account such that they may be visible to users 124 and users 124 may be able to direct donations to the organization's 216 account.

The redundant server 120 would act as a backup server to the redemption outlet server 114 in case of failure. There may be more than one redundant server 120 networked into the system 100. It would be apparent to one skilled in the art the number of redundant servers 120 required for the system 100. The redundant server 120 may be configured the same as the redemption outlet server 114. See below for the detailed description of the redemption outlet server 114. The redundant server 120 may be in constant communication with the redemption outlet server 114 receiving and transmitting data to keep the databases 210 updated and the redundant server 120 should provide at a minimum the same functionality as the redemption outlet server 114.

The system hardware of the redemption outlet server 114 may consist of a web server 202, a data bus 212, a communications section 204, a maintenance interface 206, storage 208, and a database 210. Each of these components will be described in further detail below however the delineation of these components does not indicate that the objective of the system could not be accomplished in other ways. For example, a data bus 212 is expected to be used but it is not an element of the claims and thus its function could be accomplished by another configuration of hardware or software components as an example.

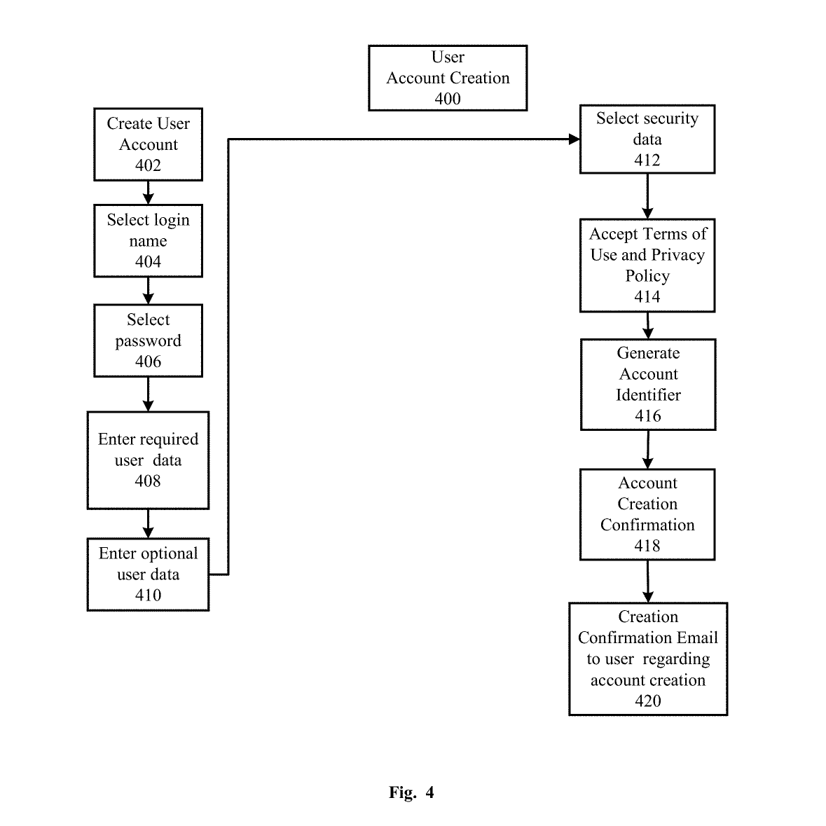

The web server 202 provides bidirectional communication to the network 214. The web server 202 may host the system web site in order to deliver web content to the users 124 which can be accessed through the network 214. This web server 202 controls the user's 124 access. The users 124 may access the different functions of the web server 202 including but not limited to user account creation 400, organization account creation 500, user account configuration 600, various user actions 700, the payment process 800, and the sales transaction 900. The web server 202 allows a user 124 to create an account via the user account creation process 400 described later in FIG. 4 in greater further detail. The web server 202 is the interface between the network 214 and the redemption outlet server 114 which communicates with the rest of the components in redemption outlet server 114 via a data bus 212.

The data bus 212 provides the data highway between all the components within the redemption outlet server 114. The communication section 204 in conjunction with the data bus 212 control the inward information flow coming from the web server 202 in the form of user 124 actions and inputs that need to be acted upon by the redemption outlet server 114 to the outward information flow as created by the responses to the actions requested by the user 124. Additionally, the communications section 204 controls the information flow to and from a database 210 and the storage 208 device and maintenance interface 206. Additionally, the webserver 202 is the interface between user device 106 and the redemption outlet server 114 and the retail store server 108 and redemption outlet server 114 processing sales transaction data 304 from both. The sales transaction data 304 is reconciled within the redemption outlet server 114 and the user 124 account is updated to reflect the new value balance.

A system maintenance interface 206 enables system administrators to update, upgrade the system, provide normal system maintenance, and provide administrative functions for the web site and system. One of these features is the ability of the administrator to control access to users 124, retailers, and organizations 206 based on factors including but not limited to abuse or failure to follow the terms and conditions. The maintenance interface 206 also allows the modification and addition of elements to tables and tables to the database 210.

Storage 208 provides a location to store the redemption outlet server 114 operating system, the web server 202 software including the mobile application interface, the database 210 information including the associated tables for the database 210. The physical configuration may be in the form of a solid state or a spinning mass hard drive or a combination thereof. Additionally, the cloud may be used as a storage medium for some of the system information. It would be apparent to one skilled in the art, the optimal physical configuration based on space, funding, and other common factors associated with electronic storage. Though the storage device 208 is shown separate from the database 210 in FIG. 2, it should be understood that the database 210 and other system data may be maintained on the storage device 208. Further, different types of computer storage may be encompassed within the storage device 208. The system may use a hard drive for some types of data storage and chip-based memory for other types of storage. It would be apparent to one skilled in the art the type of electronic storage the system would require to operate at effectively.

The database 210 stores all the user profiles and history records 302 and sales transaction data 304. The database 210 is preferably comprised of a set of tables, including but not limited to, a user profiles and history records 302 table, and a sales transaction data 304 table. Each table is described in further detail below. Generally, once a user 124 has completed a sales transaction, the data associated with the sales transaction are added to the database 210 via the user device 106, each table accepts its piece of data transferred from the electronic cash register 102 via the communication module 104 to the user device 106 and is stored within each table and associated with a single record. This configuration may allow all the associated data to be retrieved by a user 124, and may allow a retailer and an organization 216 to retrieve a limited data set based on a query.

Additionally in the system configuration 200, an organization may also create an account wherein they may be the recipient of excess currency from users 124. The organization 216 would set up an account as would a user 124 however the organization 216 may receive donations from users 124 wherein they designate a certain amount of funds to go to a specific organization 216. This process and method as to how the organization 216 will receive funds is described later.

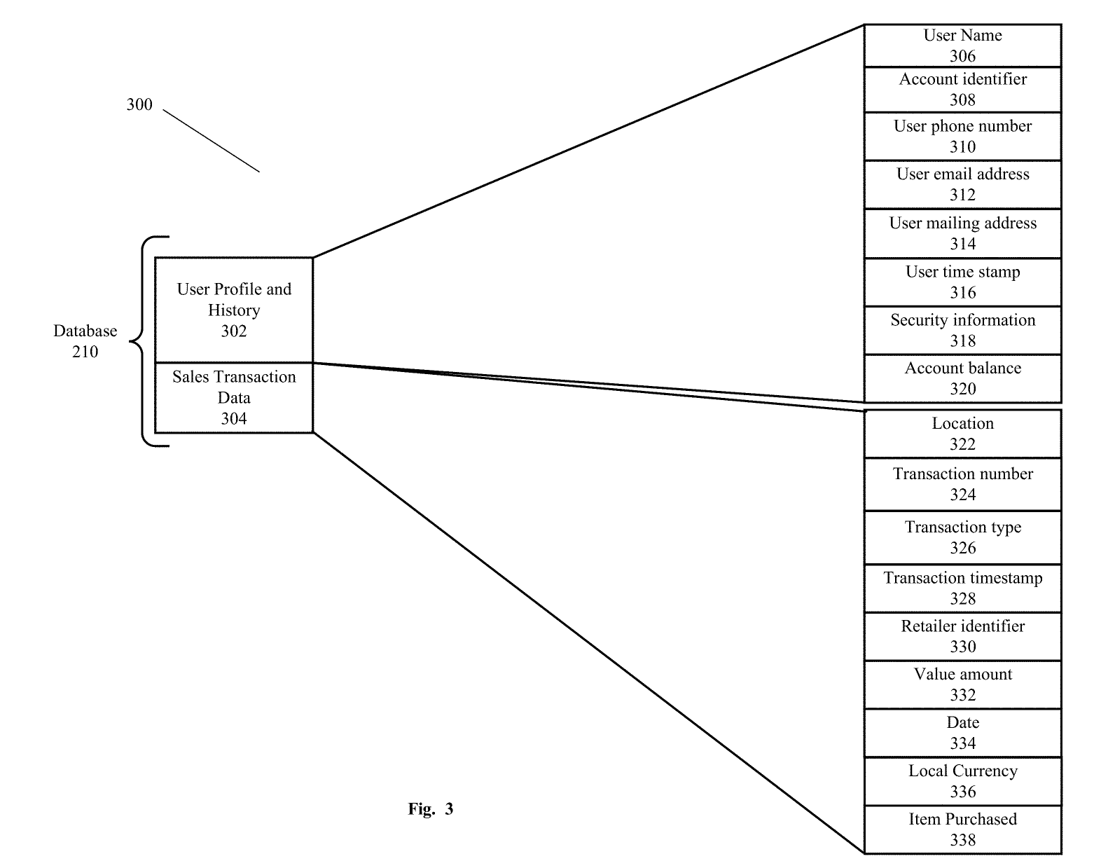

FIG. 3 illustrates the database structure 300 and its associated tables. Each time a user 124 executes a sales transaction, a unique record is created within the database 210. The database 210 in a preferred embodiment may be divided into two tables: A user profile and history table 302 and a sales transaction data table 304. The user profile data table 302 may be populated by user-entered data which is compiled to create each of these tables. Other information within the user profile table 302 may receive information that is computer generated or that is system generated. For example, a computer-generated piece of data would be the user timestamp 316 which may come from the internal clock of the redemption outlet server 114 or it may be received from the network 214. Additionally within the user profile 302, the account balance 320 is calculated through the reconciliation of the sales transaction data 304 to provide a running account balance.

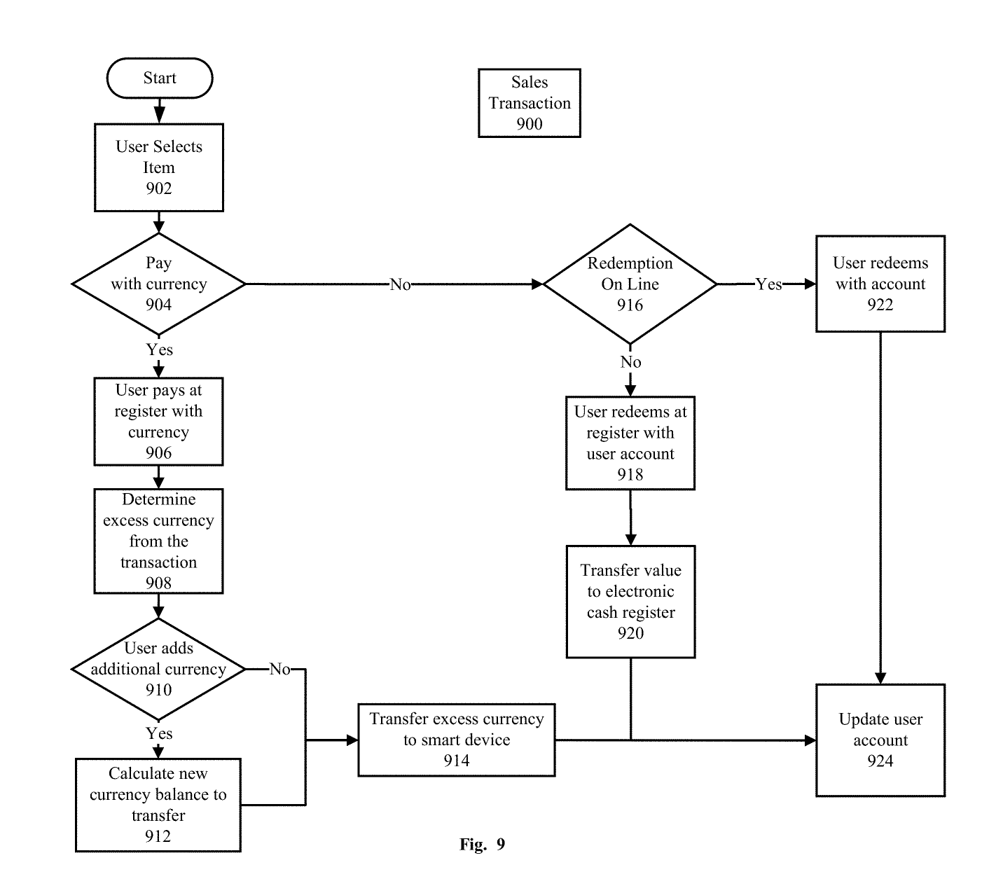

The user profile and history data table 302 may consist of a user name 306, an account identifier 308, a user phone number 310, a user email address 312, a user mailing address 314, a user timestamp 316, security information 318, and an dynamic account balance 320. The information for the user profile and history data table 302 is described in further detail in FIG. 4. The sales transaction data table 304 may comprise a location 322, a transaction number 324, a transaction type 326, transaction timestamp 328, retailer identifier 330, value amount 332, the date 334, the local currency 336, and the item purchased 338. The information for the sales transaction data table 304 is described in further detail in FIG. 9. The elements in the user profile and history 302 and the sales transaction data 304 are the preferred elements but one skilled in the art may add additional elements to these tables and could possibly increase the number of tables with other elements as required.

Each time a user 124 executes a sales transaction the data from that transaction is parsed and placed in the elements in the appropriate table as described above. The method by which this data is obtained for the user profile and history table 302 is further described in FIG. 4 user account creation 400.

After user 124 executes a sales transaction, then several pieces of information will be gathered that will then be parsed and placed in the transaction data table specifically, these may include, location of the transaction 322, transaction number 324, the transaction type 326 such as a good or service, transaction timestamp 328, the retailer identifier 330 identifying which store or chain of stores where the transaction took place, the value amount 332 that was returned to the user 124, the date 334 on which the transaction occurred, the local currency 336 in which the transaction was performed and the items purchased 338. The redemption outlet server 114 will then create a transaction number 324 associated with this transaction and a transaction timestamp 328 associated with this transaction based on the information received from the user device 106 or the information received from the retailer. The transaction type 326 may be established by one skilled in the art and may have several categories defined in the redemption outlet server 114. The items purchased element 338 may be used for geo-fencing and geo-targeting described later in FIG. 10.

The system may allow a user 124 to keep different values in their account if they travel to different locations that use different currency. The system 100 is designed to be a worldwide system, the system allows for currency to remain in its local denomination so that if a user is in Russia then value transferred would be in rubles. If you consistently travel to and from Russia from the United States, you may want separate accounts that retain currency in rubles and also in U.S. dollars. This may minimize the loss of value caused through constant exchange of currency for people who do considerable travel. The system 100 would be very advantageous to business travelers that tend to travel regularly to a specific location such as China because the user 124 could maintain the value in the account from when the user 124 was previously in China and avoid the losses associated therewith. As for one-time travelers, the system 100 may allow the user 124 to convert the value of the foreign currency into the desired currency based on the current exchange rates.

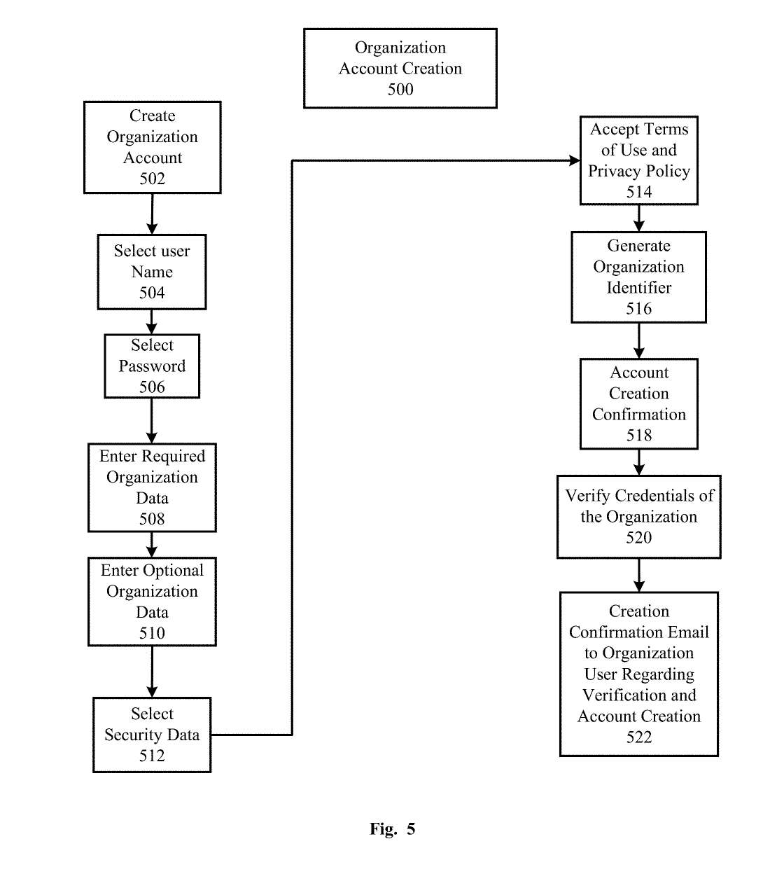

FIG. 4 illustrates a method by which a user, 124, may create an user account 402 and gain access to the functions of the system 100. A user 124 account may be a single user account, an organization account, a group account, and/or a one-way account. The single user account is discussed herein and the other accounts will be further described in FIG. 5. A user 124 may select the user account creation 400 process to initiate the user account creation 402 upon entering a web site or mobile application. The user 124 may select a user name 404, the user name preferably includes at least the first name and the last name and its associated password 406. One skilled in the art may add different requirements for the username to improve security in the view of modern hacking and cyber intrusions. Additionally, the user 124 provides the required user data 408 in order to set up the account, which preferably includes, but is not limited to, the email address. The user 124 may add other optional user data 410 to their account, such as a mailing address and a home phone number or cell phone number. The user 124 may also select security data 412 in order to protect the user's 124 account and to verify that the user 124 is who they claim to be when they logon to the system 100. Finally, the user 124 must accept terms of use and privacy policy 414 before the creation of the account 400. After acceptance of the terms of use and privacy policy 414, an account identifier 416 is generated, the user account is created and an account creation confirmation 418 is generated. After account creation confirmation 418, the redemption outlet server 114 communication section 204, may generate an account creation confirmation email 420 that is sent to the user 124 notifying the user 124 of the creation of their account. Additionally, a balance of zero may be placed in the account balance 320 and the action may be automatically timestamped 316 upon the completion of the user account creation process 400.

FIG. 5 illustrates an organization account creation process 500 by which an organization 216 may create an organizational account 502 and allow a designated user of the organization 216 to utilize the system 100. The organization account owner may include, but is not limited to, a formal organization, a group, a and/or family. These organization accounts may also be one-way accounts. A group account may be associated with groups such as Boy Scouts, local school bands, universities, colleges, or athletic teams. This group account may have several users 124 with multiple user devices 106 associated with the account. A family account is one form of a group account. For example, a family wanting the take a vacation may agree that any excess currency from sales transactions will be saved for the vacation. One member of the family may set up and control the account where multiple family users 124 may contribute to the account thereby building a desired value balance to be used for the vacation. Additionally, this family account may be one form of a one-way account where multiple family members may contribute to a single account but only one member has control of the account functions. In this form, the contributors will also be the beneficiaries of the family account. Another form of the one-way account is a charity account where charity organizations such as the United Way® may set up accounts and receive value transfers from users 124 not associated with the account other than as a contributor. Once the value is transferred, the contributor may have no input as to its use. Moreover, the users may or may not benefit from the contributions. The organization, group, and family accounts once created operate in a similar fashion as single user account.

This process is similar to the above user account creation process 400. The designated organizational account user will be referred to as the “user 124” for simplicity purposes. The user 124 may create an organizational account 500 and gain access to the functions of the system 100 and receive donations. A user 124 may select the organization account creation 502 to initiate the process upon entering a website or mobile application. The user 124 may select a user name 504, the user name consisting of at least the first name and the last name of the point of contact for the organization 216 and its associated password 506. Additionally, the user 124 provides the required organizational data 508 in order to set up the account, which preferably includes, but is not limited to, the organization's 216 email address. The user 124 may add other optional organizational data 510 to their account, such as the organization's 216 mailing address and phone number. The user 124 may also select security data 512 in order to protect the organizational account and to verify that the user 124 is allowed to access and utilize the organizational account and that user 124 is who they claim to be when they logon to the system 100. Finally, the user 124 must accept terms of use and privacy policy 514 before the creation of the account 500. After acceptance of the terms of use and privacy policy 514, an organizational identifier 516 is generated, the organizational account is created and an account creation confirmation 518 is generated. An additional step as compared to the user account creation process 400 is the verification of the organizations credentials 520 to verify that they are you they say they are. After verification of organizations credentials 520, the redemption outlet server 114 communication section 204, may generate an account creation confirmation email 522 that is sent to the user 124 notifying the user 124 of the creation of the organizational account. Additionally, a balance of zero may be placed in the account balance 320 and the action may be automatically timestamped 316 upon the completion of the organization account creation process 500. After the organizational account is created, the point of contact or some other designated representative of the organization may allow multiple user devices to be associated with the organizational account.

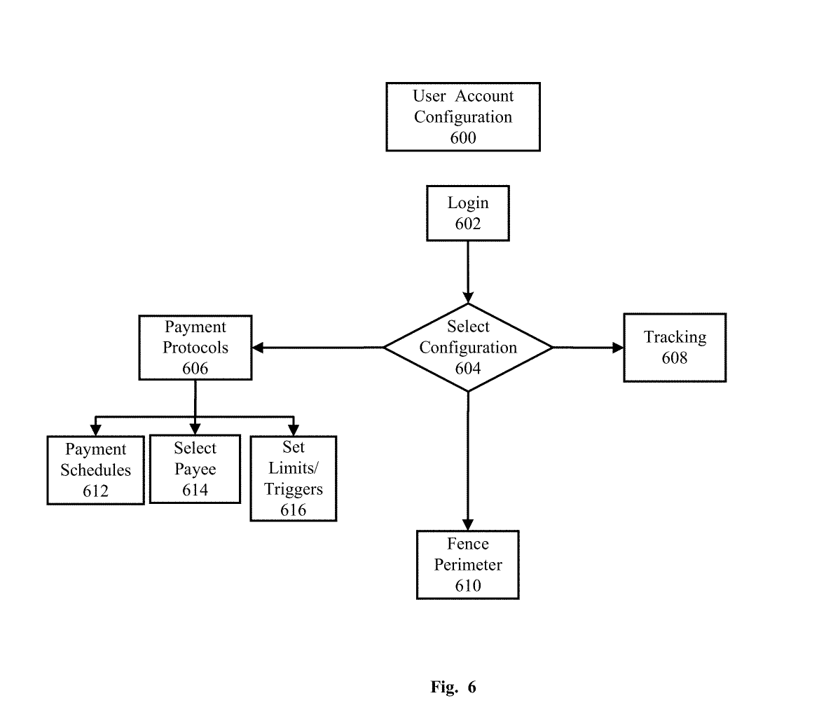

FIG. 6 illustrates the user account configuration process 600 where a user 124 may configure the settings in their account. The user 124 logs into the system 100 via a login 602 portal, which verifies their username 306 and the password credentials selected earlier in the user account creation process 400 or organizational account creation process 500. After gaining access to the system 100, the user 124 selects the configuration function 604 that they would like to modify. The user 124 may select from the following functions: payment protocols 606, tracking 608 and fence perimeter 610. Under the payment protocol 606, a user 124 may configure payment schedules 612, select payee 614 and set the limits 616. The user 124 may select from predefined payment schedules 612 or customize the payment schedule 612 to suit the user's 124 need. Additionally, the user 124 may select payee 614 to be a designated receiver which may include the organizations 216 such as charities, credit card accounts, other accounts, and investment accounts. The user 124 may configure the payee such that the payee account is automatically connected to the user 124 account. The user 124 may set limits or triggers as to the amount that a payee may receive or when the account balance 320 reaches a certain desired level then the user's 124 account will automatically transfer a determined amount of value to a payee. The amount of value transferred may be a fixed amount, a percentage thereof or a calculated amount.

The tracking 608 function may be configured to allow the position of the user 124 to be continuously tracked as described previously and transmitted to the system 100. The tracking 608 function allows the user 124 to opt-in or opt-out of the continuously tracking function. By activating tracking 608, a retailer may use geofencing and geotargeting on the user 124. Geofencing and Geotargeting will be discussed in detail in FIG. 10.

Additionally, the user 124 may set their own dynamic geofence for the user device 106 where the user 124 may select the diameter of the dynamic geofence and select the retailers for which the dynamic geofence is to apply. For this function to operate, tracking 608 may be activated but only automatic positioning discussed earlier is required. If the user 124 selects tracking 608, then the user 124 may receive notifications and advertisements for the retailers in the system 100 anytime they cross a geofence but if the user 124 does not select tracking 608 then they may only receive notifications and advertisements for the retailers they selected. For example, a user 124 may set the dynamic geofence to five miles, select 7-11® retailers, and select push notifications then any time the user 124 passes within five miles of a 7-11® retailer, the user device 106 notifies the user 124 of the location, distance, and direction. Additionally, the user device 106 may notify the detected 7-11® retailer through the system 100 to push advertisements to the user 124.

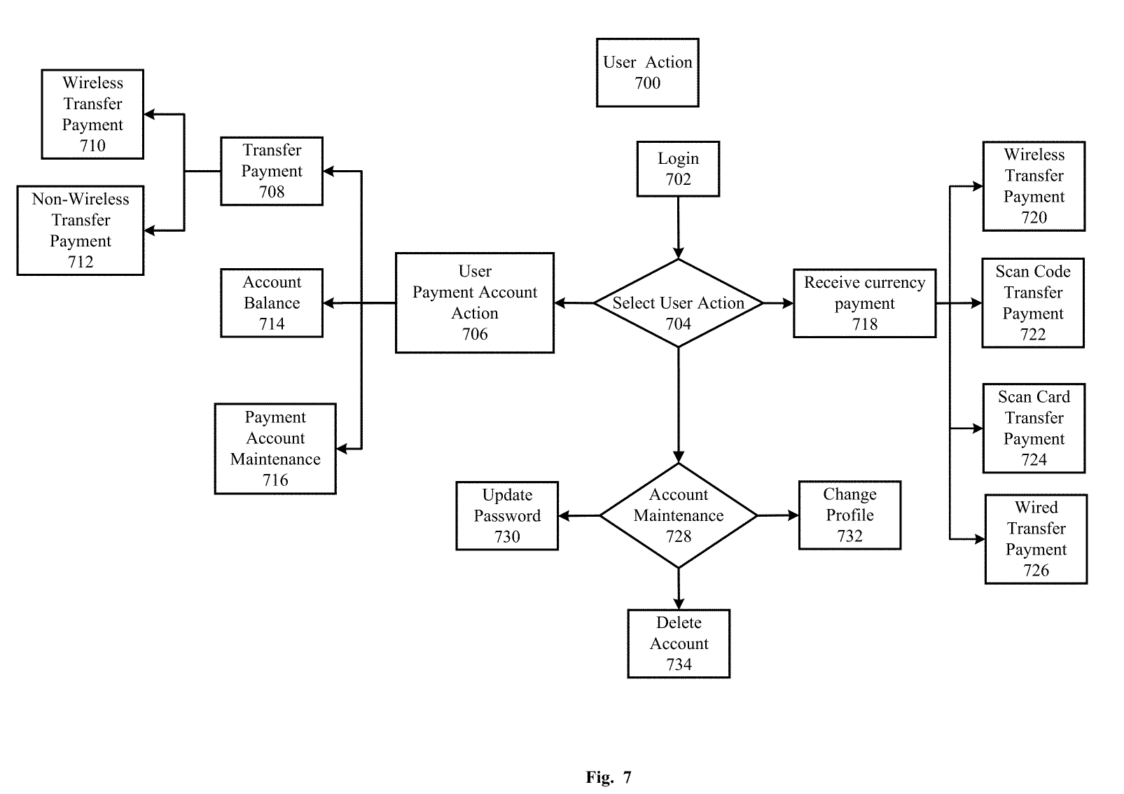

FIG. 7 illustrates the user actions 700 that are preferably available to a user 124. The user 124 use a log-in portal to login 702 with a user name 404 and password 406, which verifies the user's 124 credentials including the username and password, and the user 124 may select a desired user action 704 from one of the following: user payment account action 706, receive currency payment 718, and account maintenance 728.

When a user 124 selects user payment account action 706 they preferably have three action choices: transfer payment 708, account balance 714, and payment account maintenance 716. The transfer payment 708 action allows the user 124 to select either a wireless transfer payment 710 or a non-wireless transfer of payment 712. By selecting a wireless transfer payment 710, the user 124 may use a system similar to Apple Pay®, Google Wallet® and the like to electronically transfer the payment without physically connecting the user device 106 to the communications device 104. However, the user 124 may select a non-wireless transfer payment 712 to make the transfer by connecting the user device 106 to the communication module 104 wherein the payment would be transferred over wires to the user device 106.

The user 124 under the user payment account action 706 may select an account balance 714 function to view the current account balance 320 pending the reconciliation of the sales transaction data 304 and payment processes 800 and also project the pending balance based on the non-reconciled the transfers and payment. The user 124 may also select from the user payment account actions 706, a payment account maintenance 716 to preferably perform functions set such as setting alerts for the account balance 320 as to when it is below a specified amount or when it is above a specified amount. The payment account maintenance 716 may also allow the user 124 to configure notifications based on receiving a payment from a specific retailer or a payment being transferred to a specific organization 216 or to a retailer automatically.

The user 124 may preferably select from the select user action 704 account maintenance 728. Under account maintenance 728, the user 124 may select updating password 730, changing their profile information 732, or even deleting their account 734. These actions may be expand by one skilled in the art to cover additional functions that may be useful or required.

Another action a user 124 may select from the select user action 704 is the received value payment 718. Within the received value currency payment 718, there are preferably four methods by which a user 124 may receive payment and they are wireless transfer payment 720, a scan code transfer payment 722, a scan card transfer payment 724 and a wired transfer payment 726. Under the receive currency payment 718 the wireless transfer payment 720 is similar to the wireless transfer payment 710 as seen in the user payment account action 706 wherein the user device 106 may use applications such as Apple Pay®, Google Wallet® and similar systems to perform the wireless transfer of a payment 720 from the attendant 126 to the user 124 via the attendant's 126 electronic cash register 102 and the communication module 104 and the user's 124 user device 106. Other methods in addition to the ones described below to transfer the value wirelessly would be apparent to one skilled in the art and could include Bluetooth® or the like.

The user 124 may also receive currency payment 718 through a scan code transfer payment 722 using a universal product code (UPC) or a quick response code (QRC). The UPC is a one dimensional type of barcode that is widely used throughout the world especially in western countries for tracking items in stores. A UPC barcode in its most common form consists of unique 12 digit number assigned to a single item and encoded into the barcode. Thus when a barcode is scanned, information about a item is retrieved and displayed. The QRC is a type of matrix barcode or two-dimensional barcode and similar to the UPC in that it is scannable and contains data but the QRC has a greater storage capacity compared to standard UPC barcodes and has increased readability speed. Because of this increased storage capacity and speed more information may be included within the code without detrimentally affecting the system speed. The UPC and the QRC will be referred to as scan codes. The electronic cash register 102 may generate these scan codes with the sales transaction data 304 embedded within and then display on the communications module 104 the scan code. The user 124 may use the camera 1308 on the user device 106 to scan the code where the information is then decoded and the transaction data 304 applied to the user's 124 account.

Another method under the received currency payment function 718 is a scan card transfer payment 724 where a card with a magnetic strip is swiped in the communications module 104. The communications module embeds the sales transaction data 304 into the magnetic strip. The scan card then is transferred to the user 124 where the scan card is swiped through the card reader/writer 1212 by the user 124 to transfer the sales data that was encoded on the magnetic strip on the card and that information is then applied to the user's 124 account.

Additionally as discussed above, a wired transfer payment 726 may also be performed using the electronic cash register 102, a communication module 104 and the user device 106 wherein the user device 106 is physically connected to communication device wiring 1208 from the communication module 104 and the payment information is then transferred via the wired connection from the electronic cash register 102 to the user device 106.

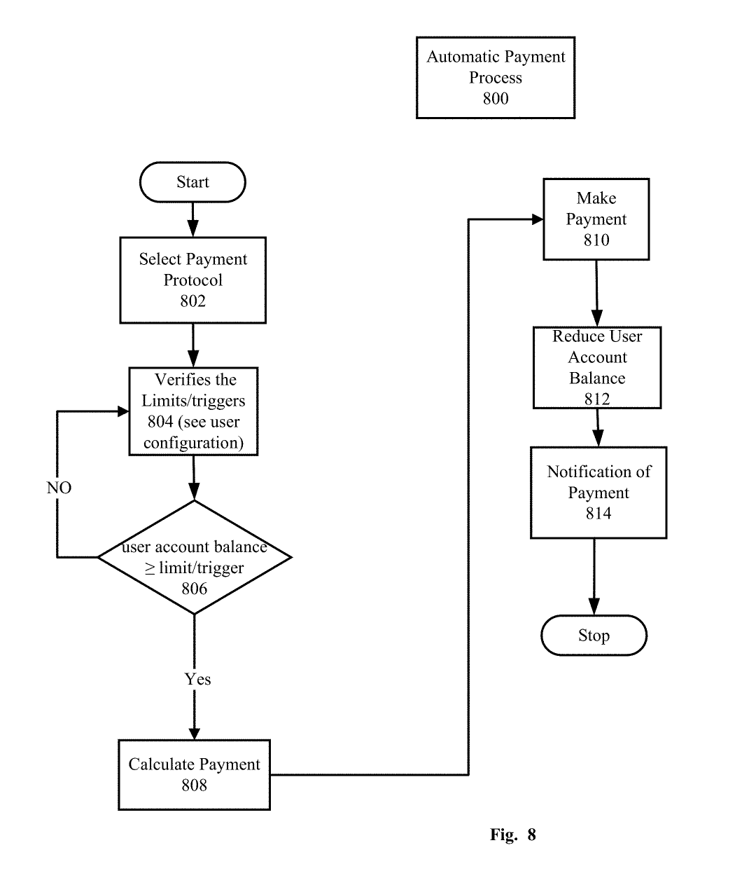

FIG. 8 is a process flow diagram illustrating one method of a preferred automatic payment process 800. This method allows a user 124 to configure an automatic payment process 800 using the user's 124 account to transfer electronic value upon meeting certain conditions. The user 124 may select different payment protocols 606 based on the user 124 configuration of the payment schedule 612, payee selection 614, and the set limits or triggers 616.

The user 124 selects payment protocol 802 wherein the user 124 verifies the limits/triggers 804 from the user account configuration process 600. The redemption outlet server 114 compares the user account balance 320 to the limit/triggers 804 set by the user 124 and the user account balance 320 comparison step determines whether the user account has exceeded the limits/triggers 806. If the user account balance 320 is within the limit/trigger then the process will create a loop checking the user account balance 320 until it exceed the limits/triggers 804. The system 100 may be configured to constantly make the limits/triggers 804 comparison or may be set to only make the comparison after a sales transaction has occurred. Once the user account balance 320 has exceeded those limits the process continues to the next step where the payment is calculated 808. Upon calculating payment 808, the process continues where the system 100 makes the payment 810 to the selected payee from the payment protocols 606 configuration in FIG. 6. Upon transferring this payment, the user's account balance reduction 812 is accomplished to reflect the new user's account balance 320. Then the user 124 may receive a notification of payment 814 from the redemption outlet server 114. This is a preferable set of steps allows the user 124 to create an automatic payment process 800 where the user 124 sets up the criteria to execute the automatic payment. Multiple payment process 800 may be made from multiple payees. The amount of value paid may include, but is not limited to, a simple fixed amount, some percentage of the user's account balance, and some percentage of the balance above the set limit. There may be other methods to calculate the automatic payment apparent to one skilled in the art.

FIG. 9 is a process flow diagram illustrating one method for a sales transaction 900. A sales transaction 900 starts by a user selecting an item 902 to purchase. The user 124 selects whether to pay with currency 904. If the user 124 pays at the register with currency 906, the electronic cash register 102 determine the excess currency from the transaction 908. At this point in the sales transaction process 900, the user 124 may want to add additional currency 910. If the user 124 desires to add additional currency, the electronic cash register 102 will calculate the new currency balance 912 based on the additional currency that the user 124 has exchanged with the attendant 126. After the additional currency has been added, the communication module 104 then transfers the excess currency to the user device 106 wherein that information is transmitted to the redemption outlet server 114. If the user 124 chooses not to add any additional currency 910 to the existing excess currency, then the communication module 104 then transfers the excess currency to the smart device 914 or otherwise so that information is transmitted to the redemption outlet server 114. Once that information is transmitted to the redemption outlet server 114, the user account 924 is updated. The user 124 may make the decision not to pay with currency 904 but instead the user 124 may redeem at the register with the user account 918. Upon redemption by the user 124, the value is transferred from the user's device 106 to the communication module 104 through the transfer value to the electronic cash register step 920. After the transfer, the users 124 account will be updated 924 to reflect the new account balance 320 minus the redemption of the selected item 902. The user 124 may also choose to make a redemption online 916 at participating retailers. The redemption process is analogous to a common internet 214 purchase herein incorporated by reference with the exception that currency is not used. The user 124 selects an item for redemption, then they follow the retailer's redemption process and use the value in the account for redemption 922. Upon transferring the value from the user account 124 to the retailer, the user account is updated 924.

FIG. 10 is a process flow diagram illustrating one method for location notification 1000. This location notification 1000 is initiated by the retailer setting the geofence perimeter 1002 around their location. The size of the geofence is determined by the retailer and their overall marketing scheme and the proximity of other similar retailers in the area.

A geofence is a virtual barrier. Geofencing is a software feature that uses GPS or radio frequency identification to define virtual geographical boundaries around a physical location. For example, a 7-11® retailer may set a five mile radius around a particular location virtually fencing it in. This geofencing allows a retailer to set up triggers so when a device enters (or exits) the boundaries defined by the geofence, a text message or email alert is sent to the user 124 via the user device 106. Many geofencing applications may incorporate Google Earth®, allowing retailers to define boundaries on top of a satellite view of a specific geographical area. Other applications may define boundaries by longitude and latitude or through user 124 created and Web-based maps.

The next step track user and user-initiated detection 1004 allows the retailer to track the user 124 if the user 124 has opted-in in the tracking function 608 configuration step of the user account configuration 600. The system 100, the retailer store sever 108 or a system that would be apparent to one skilled in the art, may be used for the tracking, geofence penetration detection and notification. In tracking the user 124 the user's 124 position is constantly compared to the geofence perimeter to detect if the user 124 has penetrated the geofence 1006. If the user 124 has not penetrated the geofence 1006 then process goes into a loop and continues checking for the geofence penetration by the user 124. If the user 124 did penetrate the geofence, the system 100 detects the user's device intrusion 1008 and at that time the system may communicate with the user device 1010 and provide the location and direction 1012 to the retailer where the user 124 penetrated the retailer's geofence. The system 100 may check the user database 1014 and the sales transaction data 304 for the user 124, to determine what they may have previously purchased from that specific retailer or a similar. The user may earn a preferred user status based on amounts, frequency, and locations of use, which provide additional benefits from the geotargeting retailer. After determining items that the user 124 is likely to purchase based on previous spending habits, the items are compared to the current discounted items 1016 and then the user 124 may be geotargeted by providing a tailored notification of the suggested discounted items to be purchased 1018 to the user 124. If there are no discounted items available, the user 124 may be geotargeted with either currently discounted items, previously purchased items or new items 1020. The user 124 has the suggested items displayed on user device 1022. Geotargeting is an active response to a geolocation of a user 124 where a retailer is able to send a tailored message to the users 124 via text or email based on their location at a given moment in time. Additionally, geotargeting allows a retailer to detect the proximity of the user's 124 location and then geotarget that user 124 based on items they normally would purchase at that specific retailer and provide notifications to the user 124 for possibly discounting selected items if they use the value maintained in their accounts for the purchase. An alternative to geotargeting, is a notification sent to the user 124 concerning all the items on sale without any specific reference to their buying habits.

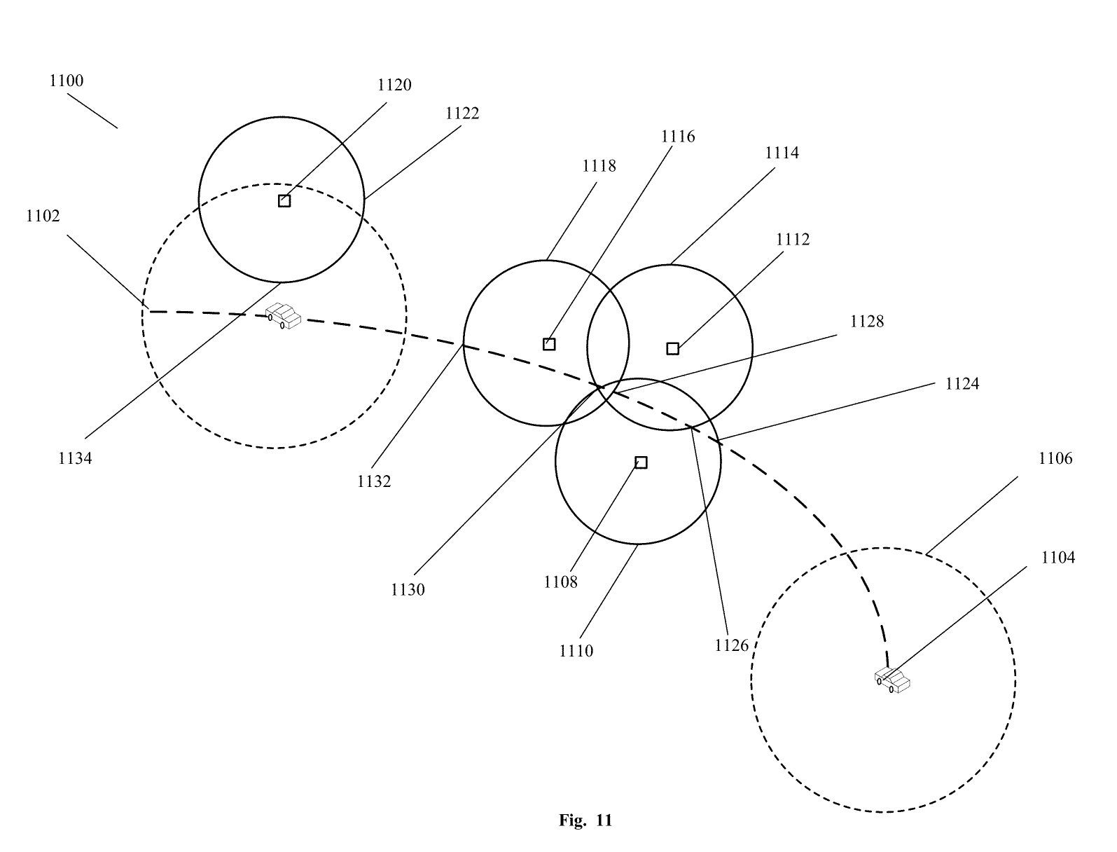

FIG. 11 is a diagrammatic illustration of geofencing using the currency conversion system 1100. In this diagrammatic illustration, the user 124 is in a user vehicle 1104 with a user device 106. Additionally, there are four retailers in this presentation. Retailer 1 is 1108 and has set up a geofence around their location and is designated retailer 1 geofence 1110. Retailer 2 (1112) is within proximity of Retailer 1 (1108) and has a Retailer 2 geofence 1114 where the two fences intersect. Retailer 3 (1116) is in proximity of Retailer 1 (1108) and Retailer 2 (1112) and has a Retailer 3 geofence 1118 set up for their location also. The last retailer, Retailer 4 (1120) is not located within proximity of Retailer 1 (1108), Retailer 2 (1112) or Retailer 3 (1116) but has set up a Retailer 4 geofence 1122 around their retail location. The user's vehicle 1104 will follow a path 1102 passing near the retailers' locations. Inside the user vehicle 1104 is the user 124 and the user device 106 with a user device geofence 1106 set.

The user 124 while in the vehicle 1104 follows the path 1102 and penetrates Retailer's 1 geofence at the first geofence penetration point 1124. Upon this penetration into the Retailer 1 geofenced area 1110, the Retailer 1 (1108) is notified of the penetration where Retailer 1 (1108) may geotarget the user 124 as previously described in in FIG. 10. Instead of geotargeting the user 124, Retailer 1 (1108) may generally send general advertising information to the user 124 which was previously described above.

As the user 102 in the vehicle 1104 continues along the path 1102 they may then penetrate Retailer's 2 geofence 1114 at the second geofence penetration 1126. Just as before once the penetration has occurred, the Retailer 2 (1112) is notified that the user 124 is within their geofence and may geotarget the user 124 along with Retailer 1 (1108).

As the user 102 in the vehicle 1104 continues along the path 1102 a third penetration 1128 may occur where Retailer 3 geofence 1118 has been penetrated by the user 124. As seen before with Retailer 1 and Retailer 2, once the geofence has been penetrated then Retailer 3 (1116) receives notification that the user 124 is within the geofence and may geotarget the user 124 as described previously with Retailer 1 (1108) and Retailer 2 (1112). At this time, based on the location of the user being within three geofences, the user 124 may be receiving notifications in the form of text message and/or emails from all threes retailers mentioned above. The system may charge a premium to one of the retailers to prevent other targeted advertisements from interfering.

As the user 124 moves along the path 1102 out through the first and second geofence exits 1130, notifications from Retailer 1 (1108) and Retailer 2 (1112) to the user 124 stop because the user 124 is no longer within either Retailer 1 and Retailer 2 geofence boundaries 1110,1114. However since the user 124 and vehicle 1104 are still within the Retailer 3 geofence 1118, the user 124 will continue to receive notifications from Retailer 3 116 as they transition through the location surrounded by Retailer's 3 geofence. As the user 124 and vehicle 1104 pass through the third geofence exit 1132 then all notifications from the retailer 3 (1116) cease.

As the user 124 and vehicle 1104 continues on the pathway 1102, they have a near miss 1134 where the user 124 does not pass through the Retailer 4 geofence 1122 but comes very close to the fence that was placed around the Retailer 4 (1120). Therefore the Retailer 4 (1120) will not push notifications to the user device 106 as was done previously with Retailer 1 (1108), Retailer 2 (1112) and Retailer 3 (1116).

If a user device 106 has a dynamic geofence set up with selected retailers as detailed in FIG. 6 and does not have tracking 608 activated, the user 124 it may request and receive selective notifications from the retailers they have selected as they pass by the retailer and the retailer penetrates the user's 124 dynamic geofence. This penetration is determined by the relative position of the user device 106 and the retailer. Upon the penetration of the dynamic geofence, the user device 106 notifies and requests the retailer through the network to provide notifications while the retailer is within the dynamic geofence. The dynamic geofence of the user 124 may be much larger and with tracking 608 activated, the user 124 would only receive notifications of the selected retailers because the user 124 may never penetrate a retailer's geofence.

FIG. 12 is a detailed view 1200 of one embodiment of a communication module 104 that may be connected separately to the electronic cash register 102 or may be integrated directly into the electronic cash register 102. The communication module 104 may comprise a communication device 1202, a display 1204, a communication device stand 1206, communication module wiring 1208, a user device connection 1210, and a card reader/writer 1212. In a preferred embodiment, the communications device 1202 and display 1204 are fixedly attached to the communications device stand 1206 where it places the display 1204 in a position for easy viewing and reach of a user 124. The communication module 104 allows a user 124 and the attendant 126 to transfers sales transaction information from the electronic cash register 102 to the user device 106. This transfer may occur by several different methods which were previously described in FIG. 7.

The preferable method utilizes proximity radio frequency systems for wireless transfer such as radio frequency identification or near-field communication to allow two-way communication between the communication module 104 and user device 106. The communication module 104 may utilize a contactless reader to receive data from a user device 106. At the end of the sales transaction, the user 124 may use the contactless reader in the user device 106 to transfer the excess currency from the electronic cash register 102 via the communications module 104. Upon the transfer, the user device 106 connects to the redemption outlet server 114 via redemption outlet server communication path 116 and transfers the sales transaction data 304. The user's 124 account is updated based on the sales transaction data 304.

Another method utilizes a code such as a UPC or QRC to transfer the money. As described earlier, a user 124 may select an item for purchase and the attendant 126 would execute the sales transaction where the excess currency 126 and the sales data would be used to create a code with the sales data embedded in the code 1214 containing the amount of currency that is due to the user 124. The user 124 using the user device 106 which will be described in detail in FIG. 13 to scan the QRC code 1214 that would be interpreted on the user's device 106 and then applied to the account.

In an alternative methods of transferring the currency the attendant 126 could encode the information on a magnetic card using the magnetic card reader/writer 1212. The attendant 126 may place the 304 on the card. The magnetic card would then be handed to the user 124 wherein the user 124 would use the user device 106 with the mobile card reader 1314 to scan the magnetic card to interpret the information and apply it to the user's 124 account. One additional method is to physically connect the user device 106 to the communication module 104 using communication device wiring 1208 that may supply power and data to the communications module 106 where the sales transaction data 304 is transferred from the communications module 104 to the user device 106. The user's 124 account is then updated with sales transaction data 304. These are some methods by which the attendant 126 may transfer the excess currency to the user 124 but other methods may be apparent to one skilled in the art.

FIG. 13 is a detailed view 1300 of one embodiment of a user device 106. The user device 106 may comprise a smart device 1302, a display 1304, a socket 1306, a camera 1308, a microphone 1310 and an activation button 1312. A user 124 may operate the user device 106 to receive the currency transfer from the attendant 126 through the electronic cash register 102 and communication module 104. The activation button 1312 removes the phone from it inactive state and may also allow the user 124 to possibly control a cursor to activate functions in the application. Additionally, the microphone maybe used to provide voice command to the user device 106 to control its activity. There are several methods to accomplish this transfer that were described previously in FIG. 12.

In a preferred embodiment, user 124 may use the proximity RF systems to transfer the currency wirelessly from the electronic cash register 102 via the communication module 104 to the user device 106. The user device 106 is held in close proximity to the communications module 104 where the contactless reader in the user device 106 automatically or upon user 124 initiation reads the sales transaction data 304 being transmitted from the communication module 104 to electronically transfer the currency without physically connecting the user device 106. As described above, the information is transferred to the redemption outlet server 114 to update the user's 124 account.

Alternately, a user 124 may transfer the excess currency by using a code 1214 and code reader software to read the code 1214 and decode the data within the code 1214 for its eventual transfer and updating of the user's 124 account on the redemption server 114. User device 106 application, may use the camera 1308 and software to scan the code 1214 to transfer the excess currency from the electronic cash register 102 via communication module 104 to the user device 106. Once the user 124 notifies the attendant 126 that they would like to transfer the excess currency into the user's 124 account, they notify the attendant 126 how they would like the currency transferred and in this case the transfer is to be accomplished by QRC code transfer. The attendant 126 then generates a QRC code 1214 based on the sales transaction data 304. The code 1214 is displayed on the communication module 104 on the display 1204 where the user 124 activates the capture software and places the user device 106 such that the camera 1308 can read the code 1214. Once the QRC code is within the capture box of the user device's 106 camera 1308 then the user may capture the code 1214 wherein the information from the code 1214 is transferred and decoded. The decoded sales transaction data 304 is transmitted to the redemption outlet server 114 where the information is then applied to the user's 124 account.

Additionally, the user 124 may use a magnetic card to effect the transfer of the excess currency from the electronic cash register 102 to the user device 106. As described in FIG. 12, the attendant 126 encodes the sales transaction on to a magnetic stripped card then physically hands the card to the user 124 where the user 124 then slides the magnetic card through the mobile card reader/writer 1314 attached to the user device 106. The mobile card reader/writer 1314 may be integrated with the user device 124 or attached to the user device 106 as seen in this figure. The sales transaction data 304 is then downloaded and decoded and the sales transaction data 304 is then applied to the user's 124 account by the same methods as describe above.

Another method is the wired transfer of the excess currency from the electronic cash register 102 to the user device 106. The sales transaction data 304 may be transmitted from the electronic cash register 102 through the communication module 104 using the user device connection 1210 which is then connected to the user device 106 at the connector socket 1306. The user 124 then activates the application software to download the sales transaction data 304, which is then applied to the user's 124 account through the redemption server 114. These four methods of currency transfer may allow the user 124 as they travel throughout the world to effectively make purchases and receive excess currency in the form of electronic value depending on the state of technology in a particular location. This system provides the user 124 multiple opportunities to use the system 100 wherein the excess currency is converted into an electronic value and then placed on their account.

Having thus described the invention, I claim:

1. A system for currency conversion comprising:
a. a currency comprising at least one denomination;
b. at least one electronic cash register adapted to receive and retain at least one currency further having a module in communication with each register;
c. at least one user device in communication with at least one module, the device including—
i. at least one user controllable command,
ii. user identification information, and
iii. system authentication information;
d. at least one user account adapted to receive and retain the value associated with at least one currency-paid transaction processed by at least one register;
e. at least one redemption outlet adapted to allow at least one user to apply any value in their user account to a desired purpose;
whereby each user retains the value associated with currency-paid transactions without the necessity of receiving and dealing with physical currency.

2. The system of claim 1, where the communication module processes each transaction using a payment system selected from Apple Pay®, the MasterCard® network, the Visa® network, the American Express® network, ACH, an RTGS system, CurrentC, Google® wallet, proximity RF, coding, magnetic strip, and wired connection.

3. The system of claim 1, where each register generates a code containing the transaction data, including at least the change due to the user.

4. The system of claim 3 where transaction data including at least an identifier of a location, an amount, and a user is transmitted to a transaction database.

5. The system of claim 4, where register displays code containing the value due to the user after the point of sale.

6. The system of claim 3, wherein some portion of transaction data is entered by a user scanning a code.

7. The system of claim 1, where the mobile device may be connected by wire adapter to cash register.

8. The system of claim 7, where the transaction data may be transferred via the wired connection.

9. The system of claim 1, where the user device is selected from a group comprising a smart mobile device, laptop, and desktop.

10. The system of claim 9, where the smart mobile device is selected from a group comprising a smart phone, tablet, watch, and a card.

11. The system of claim 1, where the user account may include a single account, a group account, a family account, and one way account.

12. The system of claim 11, where the group account has multiple smart device associated with the account.

13. The system of claim 1, where the server includes a database and a server communication section.

14. The system of claim 13, where the database stores user profile data and transaction data.

15. The system of claim 14, where user profile data may be selected from user name, user account identifier, phone number, email address, mailing address, user time stamp, security information, and account balance.

16. The system of claim 14, where the transaction data may be selected from transaction number, transaction type, value amount, date, location, transaction timestamp, local currency, item purchased, and retailor identification.

17. The system of claim 15, where the user account is configurable.

18. The system of claim 17, where the user can establish payment protocols.

19. The system of claim 18, where the user can configure payment schedules.

20. The system of claim 18, where the user account has user determinable limits.

21. The system of claim 20, where the user determined limit is reached, the account automatically pays the designated receiver selected from credit card, other account, donation, and investment accounts.

22. The system of claim 21, where the account is reduced by a fixed amount or percentage of the balance once the preset limit is reached.

23. The system of claim 1, where the account is automatically connected to accounts selected from credit card, other account, donation, and investment accounts.

24. The system of claim 1, where the user account is maintained on a server.

25. The system of claim 1, where the server maintains redundant data in multiple locations.

26. The system of claim 1, where a user supplies extra currency on hand to point of sale for conversion.

27. The system of claim 1, where the electronic currency value is maintained in a local currency based on the user's location.

28. The system of claim 1, where the system generates a geofence.

29. The system of claim 1, where the user's location is provided by an automated positioning capability of the user device.

30. The system of claim 29, where the automated positioning capability is selected from the following: multilateration, triangulation, global positioning system, WIFI, and a hybrid of at least two of the other types of capabilities.

31. The system of claim 28, where the system detects intrusion of geofence wherein the system communicates with smart mobile device.

32. The system of claim 1, wherein the system suggests at least one location near the user's location where a desired transaction may be available.

33. The system of claim 1 where data from the transaction database is analyzed to suggest specific items at a location near at least one user that may interest the user based on their prior transactions.

34. A system for converting currency from a cash point of sale to electronic value stored in a record, for use in a later transactions, the system comprising:
a. at least one electronic cash register;
b. at least one communications module;
c. at least one mobile device in communication with at least one module, the device including—
i. at least one user controllable command,
ii. user identification information, and
iii. system authentication information;
d. at least one server having—
i. at least one user account adapted to receive and retain the value of currency associated with at least one currency-paid transaction processed by at least one register,
e. a currency comprising at least one denomination;
f. at least one network; and
g. at least one cellular network,
whereby the user has the physical currency from a cash transaction converted to electronic currency transferred to a smart mobile device in communication with the server where it is stored and tracked by the system wherein the user may use the stored currency in the future without carrying around all the change.

35. A method for converting currency into electronic data for use in a later transaction, the method comprising:
a. utilizing the system of claim 1 for converting currency and storage of electronic record;
b. paying for a desired item by user with currency at a electronic cash register;
c. converting currency remainder into electronica data;
d. creating a record in a database for each user entry of payment transfer information;
e. transferring the data from the electronic cash register to a smart mobile device;
f. updating database record for at least one user account;
g. storing a record of the currency amount in a database;
h. cumulating currency from additional transactions;
i. updating a user database record with the additional currency;
j. selecting a future transaction;
k. paying for desired item with currency from electronic record;
l. transferring the data from the database record via the smart mobile device to an electronic cash register; and
m. updating database record for at least one user account by reducing the account by the amount of the purchased item,
whereby a user purchases an item from a retailer with cash and receives the currency electronically from the electronic cash register communicating with a smart mobile device wherein a database tracks the transactions and updates the database.

36. The method of claim 35, where users can earn preferred user status based on amounts, frequency, and locations of use.

37. The method of claim 35, wherein a payment transaction data is entered by scanning a generated QRC or UPC data code.

38. The method of claim 35, wherein transaction payment information data includes at least one of the following: retailer, currency, location, date, and time of purchase.

39. The method of claim 35, where a system detects user's location by the intrusion of a retailer's geo-fence.

40. The method of claim 39, where a user's location is provided by an automated positioning capability of the user device.

41. The method of claim 40, where the automated positioning capability is selected from the following: multilateration, triangulation, global positioning system, WIFI, and a hybrid of at least two of the foregoing.

42. The method of claim 35, the smart mobile device identifies retailers using the system in close proximity to the user.

43. The method of claim 35, the system may communicate with smart mobile device and display relevant information to the user.
